(19) United States
(12) Patent Application Publication
(10) Pub. No.: US 2018/0176274 A1
(43) Pub. Date: Jun. 21, 2018

(54) PRESET ASSIGNMENTS FOR STREAMING MUSIC PLAYERS

(71) Applicant: BOSE CORPORATION, Framingham, MA (US)

(72) Inventors: Glenn Gomes-Casseres, Newton, MA (US); Santiago Carvajal, Ashland, MA (US)

(21) Appl. No.: 15/383,754

(22) Filed: Dec. 19, 2016

(51) Int. Cl. H04L 29/06; H04L 29/08

(52) U.S. Cl. CPC H04L 65/4092; H04L 67/22

(57) ABSTRACT

A method of assigning streaming audio content to a preset of a streaming music player of a user includes receiving an indication of long form streaming audio content for a user, receiving an indication of short form streaming audio content for the user, the long form streaming audio content and the short form streaming audio content being supplied from different sources, and configuring a preset of the streaming music player of the user to play the long form streaming audio content and the short form streaming audio content responsive to the preset being selected.

### TECHNICAL FIELD

Aspects and implementations of the present disclosure are directed generally to streaming media player devices and specifically to systems and methods for assigning multiple forms of content to preset channels.

### BACKGROUND

Streaming media players, for example, streaming music players, allow a user to access and stream content from external sources, for example, from Internet radio stations or other Internet-based streaming media service providers. Some streaming music players include functionality for storing preset or favorite channels or stations such that a user may access a favorite channel or station by, for example, actuating an button or other feature associated with the favorite channel on the streaming music player or on a controller for the streaming music player.

### SUMMARY

In accordance with an aspect of the present disclosure, there is provided a method of assigning streaming audio content to a preset of a streaming music player of a user. The method comprises receiving an indication of long form streaming audio content for a user, receiving an indication of short form streaming audio content for the user, the long form streaming audio content and the short form streaming audio content being supplied from different sources, and configuring a preset of the streaming music player of the user to play the long form streaming audio content and the short form streaming audio content responsive to the preset being selected.

In some implementations, receiving the indication of the long form streaming audio content and the indication of the short form streaming audio content comprises receiving the indication of the long form streaming audio content and the indication of the short form streaming audio content from the user.

In some implementations, the method further comprises receiving a schedule for playing the long form streaming audio content and the short form streaming audio content and playing the long form streaming audio content and the short form streaming audio content in accordance with the schedule responsive to the preset being selected.

In some implementations, receiving the schedule includes receiving an indication of timing of when to interrupt playing of the long form streaming audio content with the short form audio content.

In some implementations, receiving the schedule includes receiving an indication of a type of short form audio content to play based on criteria including one or more of duration, time of day, day of week, season, or location of user.

In some implementations, receiving the schedule includes receiving an indication of a type of long form audio content to play based on criteria including one or more of duration, time of day, day of week, season, or location of user.

In some implementations, receiving the schedule includes receiving an indication of a first type of short form audio content to interrupt playing of the long form audio content at a first periodic basis and an indication of a second type of short form audio content to interrupt playing of the long form audio content at a second periodic basis.

In some implementations, receiving the indication of the long form streaming audio content and the indication of the short form streaming audio content comprises receiving the indication of the long form streaming audio content and the indication of the short form streaming audio content from a computer system that predicted a type of long form streaming audio content and a type of short form streaming audio content that the user would likely enjoy based on one or more characteristics of the user.

In some implementations, the method further comprises creating, by the computer system, a schedule for playing the long form streaming audio content and the short form streaming audio content that the user would likely enjoy based on one or more characteristics of the user, and playing the long form streaming audio content and the short form streaming audio content in accordance with the schedule responsive to the preset being selected.

In some implementations, receiving the indication of short form streaming audio content comprises receiving an indication of short form streaming audio content from a plurality of sources.

In some implementations, the method further comprises interrupting playing of the long form audio content with the short form audio content responsive to an occurrence of an event.

In some implementations, the method further comprises monitoring, by the steaming music player, external sources of information for an indication of the occurrence of the event.

In some implementations, the method further comprises programming the streaming music player to perform a specific action responsive to receipt of an indication of the occurrence of the event.

In some implementations, the method further comprises interrupting playing of the short form audio content responsive to receiving an indication of an occurrence of an event from an external source of information monitored by the streaming music player.

In some implementations, the method further comprises receiving indications of long form streaming audio content and short form audio content for more presets than are physically present on the streaming music player, storing the indications of long form streaming audio content and short form audio content in an online account of the user, downloading one or more of the indications of long form streaming audio content and short form audio content to the streaming music player, and assigning the one or more of the indications of long form streaming audio content and short form audio content to one or more respective presets of the streaming music player.

In some implementations, configuring the preset of the streaming music player comprises configuring a virtual preset accessible and selectable through a controller of the streaming music player.

In accordance with another aspect, there is provided a computer system comprising a processor and a non-transitory computer readable memory including instructions that when executed by the processor cause the computer system to receive an indication of long form streaming audio content and short form streaming audio content for a user, the long form streaming audio content and the short form streaming audio content being supplied from different sources, and configure a preset of a streaming music player of the user to play the long form streaming audio content and short form streaming audio content responsive to the preset being selected.

In some implementations, the instructions, when executed by the processor, further cause the computer system to receive a schedule for playing the long form streaming audio content and the short form streaming audio content, the schedule including an indication of timing of when to interrupt playing of the long form streaming audio content with the short form audio content and an indication of a type of short form audio content to play based on criteria including one or more of time of day, day of week, season, and location of user, and configure the preset of the streaming music player of the user to play the long form streaming audio content and short form streaming audio content in accordance with the schedule.

In some implementations, the instructions, when executed by the processor, further cause the computer system to dynamically adjust one or more of a type of the long form streaming audio content, a type of the short form streaming audio content, or the schedule based on one or more characteristics or actions of the user.

In accordance with another aspect, there is provided a streaming music player comprising a processor, a network interface operatively coupled to the processor and configured to access streaming audio content from one or more streaming audio content sources, an electro-acoustic transducer operatively coupled to the processor, and a plurality of preset indicators operatively coupled to the processor, each of the plurality of preset indicators configured to initiate streaming and rendering of a combination of long form audio content and short form audio content from different streaming audio content sources through the electro-acoustic transducer.

In some implementations, the streaming music player further comprises a memory operatively coupled to the processor, the memory including programming which when executed by the processor causes the processor to access a cloud-based database including account information associated with the streaming music player including a set of combinations of indications of long form streaming audio content and short form audio content from different streaming audio content sources and to assign one of the combinations to one of the plurality of preset indicators.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1A is a perspective view of an exemplary streaming music player;

FIG. 1B is a plan view of the streaming music player of FIG. 1A;

FIG. 1C is a block diagram of the streaming music player of FIG. 1A;

FIG. 1D illustrates a controller for the streaming music player of FIG. 1A;

FIG. 2 is a flow chart of an exemplary method for a user to program presets of a streaming music player to play long form and short form content;

FIG. 3 illustrates an exemplary user interface for creating a schedule for content to assign to a preset of a streaming music player; and

FIG. 4 illustrates a computer system upon which aspects of methods disclosed herein may be performed.

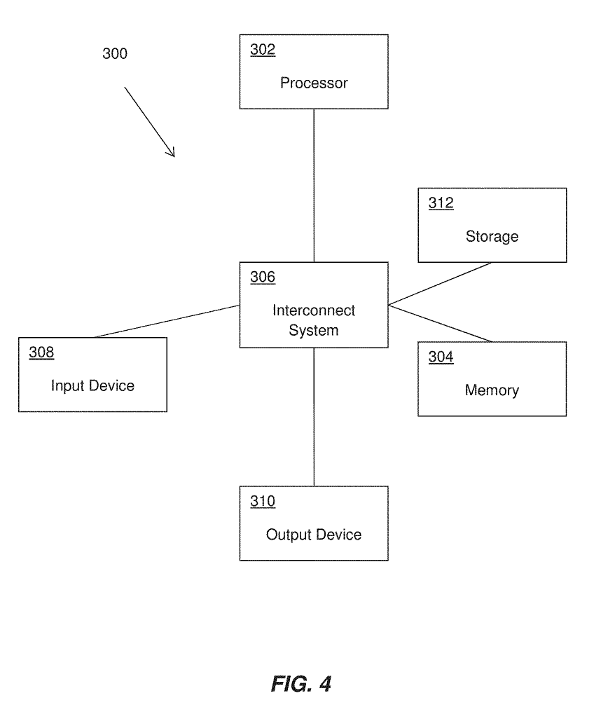

### DETAILED DESCRIPTION

Aspects and implementations disclosed herein are not limited to the details of construction and the arrangement of components set forth in the following description or illustrated in the drawings. Aspects and implementations disclosed herein are capable of being practiced or of being carried out in various ways.

Aspects and implementations disclosed herein are generally directed to systems and methods for assigning multiple sources of streaming audio, for example, from different playlists or channels, to an individual preset of a streaming music player and defining when content from the different sources are played when the preset is selected. The terms “stations” and “channels” are used interchangeably herein and encompass Internet radio channels, playlists from Internet streaming services, or other pre-defined locations or access points for accessing streaming music or other audio content, for example, news, sports, weather, etc. Although referred to herein as a “streaming music player,” it is to be understood that the disclosed streaming music player may be utilized to stream audio content other than music. The systems and methods disclosed herein may extend the functionality of streaming music player presets, and may expand the extent to which presets of a streaming music player may be customized for a particular user.

In some implementations, presets of a streaming music player may be assigned channels for both “long form” content and “short form” content. The long form content may be an audio playlist, Internet music channel, audio book or other type of content that a user may listen to for an extended period of time. The short form content may be information that may conveyed quickly to a user, for example, weather information, sports scores, stock market information, news highlights, etc. As the term is used herein, short form content does not include commercial advertisements. The long form content and the short form content may be provided from different sources.

A preset of a streaming music player may be programmed to add the short form content into the long form content, for example, to play the short form content first when a preset is selected by the user and then switch to the long form content. In other examples, preset may be programmed to play the short form content periodically, for example, once per hour, or may be programmed to interrupt the long form content upon the occurrence of an event, for example, to report an accident, play an emergency alert, provide information regarding a breaking news story, etc. The long form content may resume after the interrupting short form content has been played. In other examples, a type of short form content may include a doorbell or a fire alarm, and the long form content may be interrupted so that the user can hear the doorbell or fire alarm or the streaming music player may interrupt the long form content to play a replication or other indicator of the doorbell or fire alarm. The type of short form content that is played, the type of long form content that is played, a schedule for interrupting the long form content to play the short form content, the length of time devoted to the short form content vs. the long form content, etc., may be varied based on time of day, day of the week, location of the user, or other parameters. Any one or more of the type of short form content that is played, the type of long form content that is played, a schedule for interrupting the long form content to play the short form content, the length of time devoted to the short form content vs. the long form content, etc. may be dynamically adjusted based on the history of usage of the streaming music player by the user. There can be multiple instances of long form content and short from content associated with the same preset.

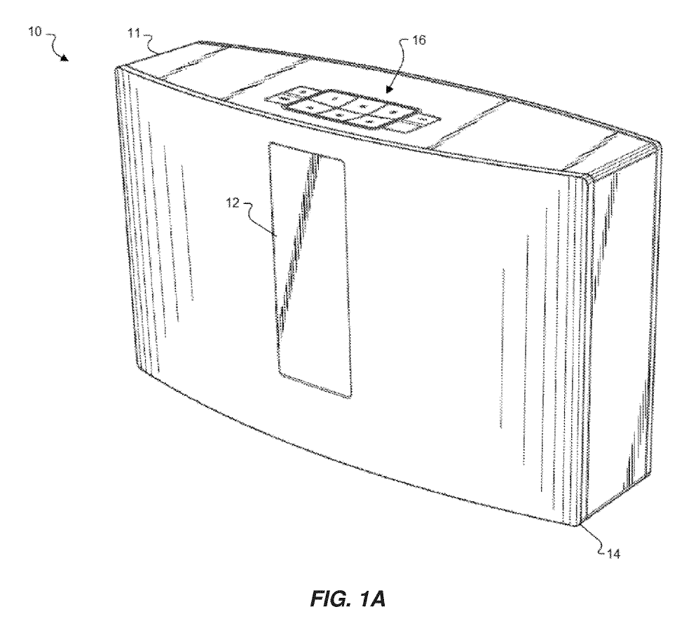

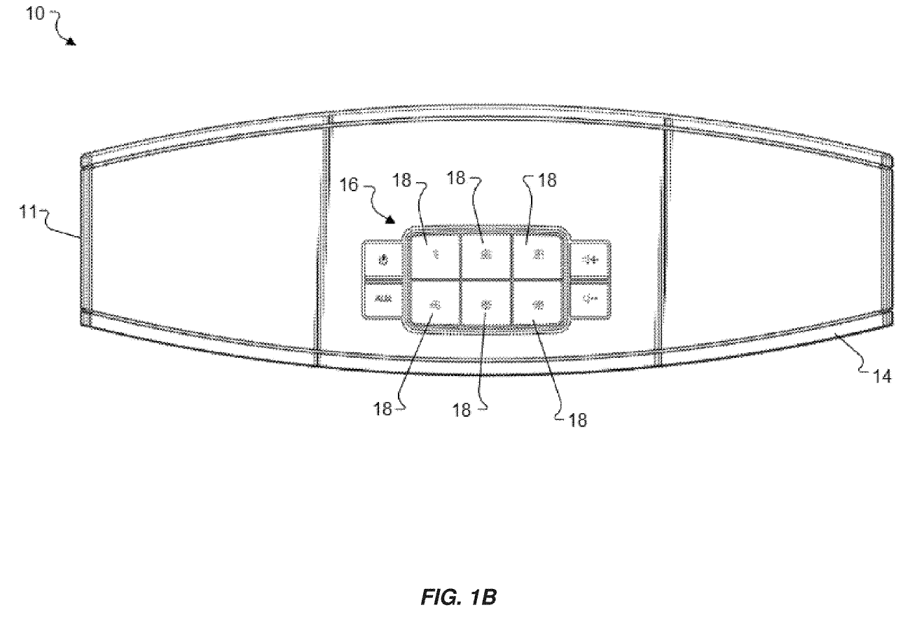

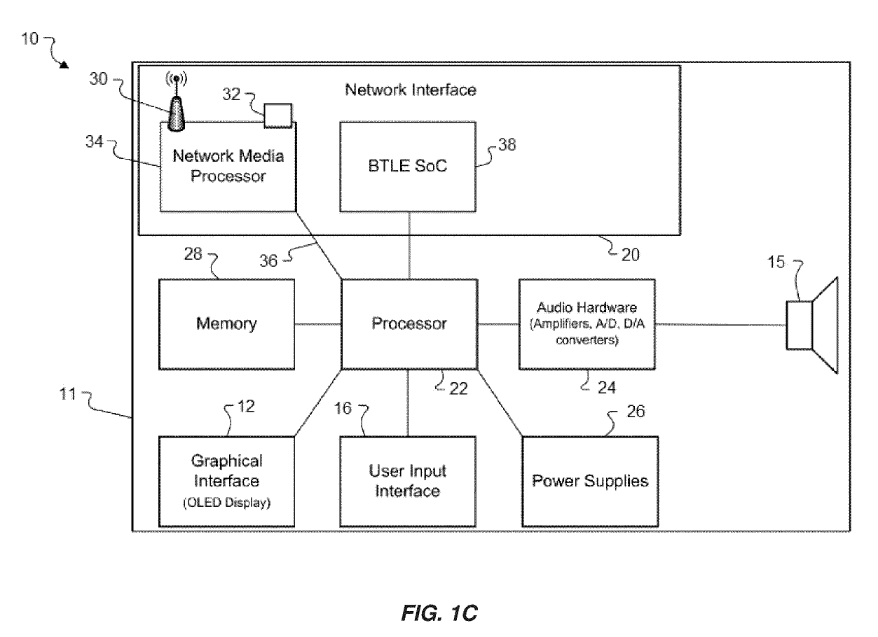

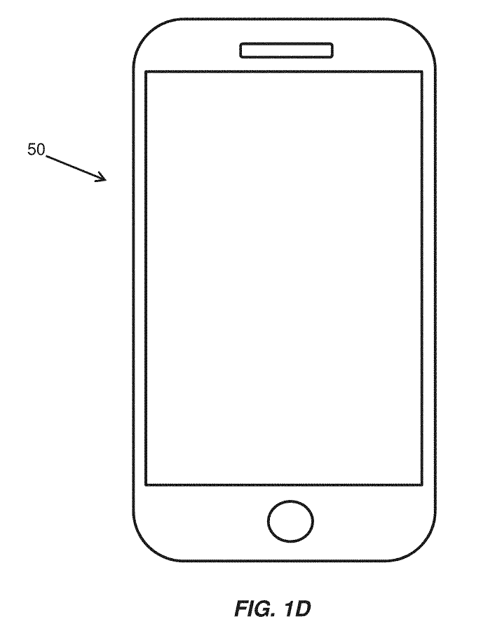

The aspects and implementations disclosed herein are generally applicable to any one of multiple streaming music players. In one particular implementation, the streaming music player is one of the SoundTouch® audio playback devices available from the Bose Corporation. An example of such a system is illustrated in FIGS. 1A-1C. This device is described in co-owned U.S. Pat. No. 9,330,169 “AUDIO SYSTEMS AND RELATED DEVICES AND METHODS,” which is incorporated herein by reference in its entirety for all purposes.

Referring to FIG. 1A, the audio playback device 10 includes an enclosure 11 and on the enclosure 11 there resides a graphical interface 12 (e.g., an OLED display) which can provide a user with information regarding currently playing (“Now Playing”) music and information regarding the presets. A screen 14 conceals one or more electro-acoustic transducers 15 (FIG. 1C). The audio playback device 10 also includes a user input interface 16. As shown in FIG. 1B, the user input interface 16 includes a plurality of preset indicators 18, which are hardware buttons in the illustrated example. The preset indicators 18 (numbered 1-6) provide the user with easy, one press access to entities assigned to those buttons. That is, a single press of a selected one of the preset indicators 18 will initiate streaming and rendering of content from the assigned entity or entities. As disclosed herein, in some examples, multiple entities may be assigned to the same preset so that the same preset will provide a user with both long form content and short form content.

The assigned entities can be associated with different digital audio sources, for example, stations, channels, or playlists from Internet radio stations or streaming music services such as the Pandora®, Spotify®, vTuner®, iHeartRadio®, Deezer®, SiriusXM®, Amazon Music, etc. services. A single audio playback device 10 can provide for single press access to various different digital audio sources. In one example, the assigned entities include at least (i) user-defined playlists of digital music and (ii) Internet radio stations. In another example, the digital audio sources include a plurality of Internet radio sites, and the assigned entities include individual radio stations provided by those Internet radio sites.

Notably, the preset indicators 18 operate in the same manner, at least from the user's perspective, regardless of which entities are assigned and which of the digital audio sources provide the assigned entities. That is, each preset indicator 18 can provide for single press access to its assigned entity or entities whether an entity is a user-defined playlist of digital music provided by a network attached storage (NAS) device or an Internet radio station provided by an Internet music service.

With reference to FIG. 1C, the audio playback device 10 also includes a network interface 20, a processor 22, audio hardware 24, power supplies 26 for powering the various audio playback device components, and memory 28. Each of the processor 22, the graphical interface 12, the network interface 20, the audio hardware 24, the power supplies 26, and the memory 28 are interconnected using various buses, and several of the components may be mounted on a common motherboard or in other manners as appropriate.

The network interface 20 provides for communication between the audio playback device 10 and a controller (for example, a remote control or a smart phone or computer having an appropriate control application installed), a server connected to the Internet or cloud-based server that may contain an account database including information regarding an audio system account of a user, audio sources, and other audio playback devices 10 via one or more communications protocols. The network interface 20 may provide either or both of a wireless interface 30 and a wired interface 32. The wireless interface 30 allows the audio playback device 10 to communicate wirelessly with other devices in accordance with a communication protocol such as such as IEEE 802.11b/g. The wired interface 32 provides network interface functions via a wired (e.g., Ethernet) connection.

In some examples, the network interface 20 may also include a network media processor 34 for supporting Apple AirPlay® (a proprietary protocol stack/suite developed by Apple Inc., with headquarters in Cupertino, Calif., that allows wireless streaming of audio, video, and photos, together with related metadata between devices). For example, if a user connects an AirPlay® enabled device, such as an iPhone or iPad device, to a LAN which the audio playback device 10 is in communication with, the user can then stream music to the network connected audio playback devices 10 via Apple AirPlay®. A suitable network media processor is the DM870 processor available from SMSC of Hauppauge, N.Y. The network media processor 34 provides network access (e.g., the Wi-Fi network and/or Ethernet connection can be provided through the network media processor 34) and AirPlay® audio. AirPlay® audio signals are passed to the processor 22, using the I2S protocol (an electrical serial bus interface standard used for connecting digital audio devices), for downstream processing and playback. Notably, the audio playback device 10 can support audio-streaming via AirPlay® and/or DLNA's UPnP protocols, and all integrated within one device.

All other digital audio coming from network packets comes straight from the network media processor 34 through a USB bridge 36 to the processor 22 and runs into the decoders, DSP, and eventually is played back (rendered) via the electro-acoustic transducer(s) 15.

The network interface 11 can also include a Bluetooth low energy (BTLE) system-on-chip (SoC) 738 for Bluetooth low energy applications (e.g., for wireless communication with a Bluetooth enabled controller. A suitable BTLE SoC is the CC2540 available from Texas Instruments, with headquarters in Dallas, Tex.

Streamed data pass from the network interface 20 to the processor 22. The processor 22 can execute instructions within the audio playback device (e.g., for performing, among other things, digital signal processing, decoding, and equalization functions), including instructions stored in the memory 28. The processor 22 may be implemented as a chipset of chips that include separate and multiple analog and digital processors. The processor 22 may provide, for example, for coordination of other components of the audio playback device 10, such as control of user interfaces, or applications run by the audio playback device 10. A suitable processor is the DA921 available from Texas Instruments.

The processor 22 provides a processed digital audio signal to the audio hardware 24 which includes one or more digital-to-analog (D/A) converters for converting the digital audio signal to an analog audio signal. The audio hardware 24 also includes one or more amplifiers which provide amplified analog audio signals to the electroacoustic transducer(s) 15 for playback. In addition, the audio hardware 24 may include circuitry for processing analog input signals to provide digital audio signals for sharing with other devices.

The memory 28 stores information within the audio playback device 10. In this regard, the memory 28 may store account information, such as information regarding the audio station or channel presets. The memory 28 may also provide storage for “tokens” for facilitating single press access to the digital audio sources, for example, Internet radio services. A token, as used herein, is a unique identifier that may be provided by a digital audio source and which allows the digital audio source to recognize the audio playback device 10 as being associated with a user's account with the digital audio source and without requiring the user to enter credentials (e.g., user name, password, etc.) each time the audio playback device 10 attempts to access the digital audio source.

The memory 28 may include, for example, flash memory and/or non-volatile random access memory (NVRAM). In some implementations, instructions (e.g., software) are stored in an information carrier. The instructions, when executed by one or more processing devices (e.g., the processor 22), perform one or more processes, such as those described below for assigning stations, channels, or playlists (long form content and short form content) to the preset indicators 18 of the streaming music player. The instructions can also be stored by one or more storage devices, such as one or more computer- or machine-readable mediums (for example, the memory 28, or memory on the processor). The instructions may include instructions for performing decoding (i.e., the software modules include the audio codecs for decoding the digital audio streams), as well as digital signal processing and equalization. In accordance with some aspects and implementations, the memory 28 includes instructions, that when executed by the processor causes the processor to access a cloud-based database including account information associated with the audio playback device 10 including a set of user-defined audio channel presets and to assign the user-defined audio channel presets to the plurality of preset indicators 18.

A user may operate the streaming music player by interacting directly with the user input interface 16. Alternatively, a user may operate the streaming music player using an app installed on a streaming music player controller, for example, a smart phone 50 (FIG. 1D) or other mobile device. In some implementations, in addition to or as an alternative to assigning content to hardware preset indicators 18 provided on the streaming music player, content may be assigned to “virtual presets” that are accessible and selectable through the app installed on the streaming music player controller. Accordingly, discussion herein of assigning content to the preset indicators 18 of the streaming music player applies equally to assigning content to “virtual presets” accessible and selectable through the app installed on the streaming music player controller.

### Preset Programming

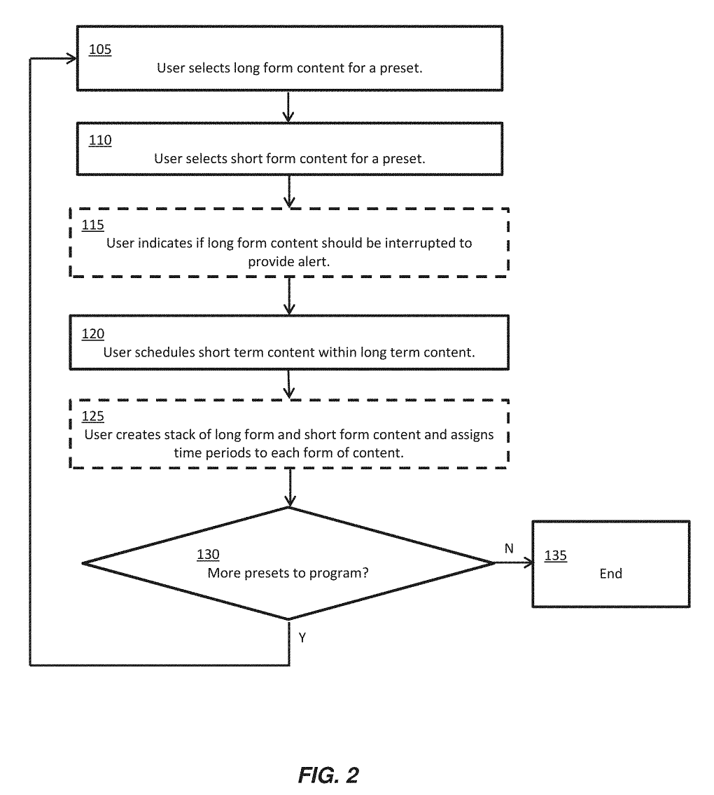

A flowchart illustrating one example of programming a preset (or presets) of a streaming music player in accordance with one or more implementations disclosed herein is illustrated in FIG. 2. The method may be performed through the user input interface 16 of a streaming music player, through a controller for a streaming music player, or may be performed via a personal computer, laptop, or other mobile computing device by accessing the online account of a user associated with the user's streaming music player and entering the parameters defining the programming of the preset into the user's online account for later access by the streaming music player or controller of the streaming music player.

In act 105 the user selects long form content to be assigned to the preset. The long form content may be, for example, a playlist or audio channel of a streaming music service, an online audiobook, or other audio content that is available for streaming from the Internet or other source. In some implementations, the user may select multiple types of long form content from different sources.

In act 110 the user selects short form content to be assigned to the preset along with the selected long form content. The short form content may be content from a channel of a streaming music service that provides sports scores, news, financial information, weather information, or any other form of information that can be conveyed to a user in a relatively short time frame, for example, in less than about 10 minutes, less than five minutes, or less than a minute, or that the user wants to hear for a shorter length of time than the long form content. In some implementations, the user may select multiple types of short form content from different sources.

In optional act 115, the user indicates whether or not playing of the long form content and/or short form content should be interrupted responsive to the occurrence of a particular type of event and what the streaming music player should do responsive to the occurrence of the event. The user may indicate that the long form content and/or short form content should be interrupted responsive to, for example, a breaking news story being released, the occurrence of an accident in the vicinity of the user or involving someone known to the user, a fire alarm being triggered, a doorbell being activated, or other event that the user wishes to be notified of. The streaming music player may monitor sources of information or receive notifications from other devices. For example, the streaming music player may monitor or receiving information from a news channel, a streaming police alert channel, an emergency response system channel, a GPS system, Wi-Fi router, an automobile, a mobile device, a fire alarm or doorbell. This information may be played on the streaming music player, and may interrupt either short form content or long form content. An alert may also interrupt short form content or long form content.

The user may further specify what action the streaming music player should take responsive to the occurrence of the event. For example, the user may specify that in response to occurrence of a specific type of event the long form content or short form content should be interrupted and the content of an emergency alert, a breaking news story, or audio content associated with another event should be played through the streaming music player. In other examples, the user may specify that the long form content should simply be interrupted so that the user could more easily hear an alarm or doorbell. In further examples, the user may specify that in response to occurrence of a specific type of event the long form content should be interrupted and a special tone or message should be played informing the user of the occurrence of the event so that the user may seek further details by, for example, accessing a web site through a separate computing device.

In act 120, the user specifies when the short form content should be played in lieu of the long form content. The user may, for example, schedule the short form content to play before the long form content when the preset is selected. In some implementations, the user may schedule multiple types of short form content, for example, news, weather and traffic updates to play before the long form content when the preset is selected. Alternatively the user may schedule the long form content to play for at least a minimum amount of time before being interrupted by the short form content. The user may schedule the short form content to interrupt the long form content and play on a periodic basis, for example, once per hour. In some implementations the user may schedule multiple types of short form content to interrupt the long form content and play on a different periodic basis, for example, to provide updates on sports scores every 15 minutes while a game the user is interested in is playing, and to provide news updates once every two hours.

The user may program blocks of content, for example, 10 minutes of news, 40 minutes of music, five minutes of traffic updates, and five minutes of sports updates to play as repeated blocks with the short form content and long form content updated for each repetition. The type or frequency of short form content interruptions may be scheduled to vary based on time of day or location. For example, the user may schedule weather information to be provided in the morning, but at a lesser frequency or not at all in the evening. The user may schedule news updates to be provided in the morning, but for sports information to be provided instead of news updates in the evening. The user may also or additionally schedule different types of short form content and long form content to play based on the day of the week, for example, for sports updates to be played more often on weekends than on weekdays and financial news to be played more often on weekdays than on weekends or holidays. The user may schedule different types of short form content and long form content to be played at different times of the year, for example, football scores to be played only during football season, baseball scores to be played only during baseball season, and holiday music only during the holiday season. If the user has a streaming music player installed in his/her car, the user may schedule traffic update information to interrupt the long form content while the user is in the car but for news updates to interrupt the long form content while the user is listening to the long form content on a same preset in a streaming music player in the user's home or office.

In some implementations, the user may schedule a preset to play different channels of long form content as well as or instead of different forms of short form content. For example, the user may want to play more energetic music in the morning to help wake up, but more relaxing music in the evening to help wind down. In one example, a user may program a preset to play music from a first channel periodically interrupted by news updates in the morning, music from a second channel without short form content interruptions in the afternoon, and music from a third channel periodically interrupted by sports updates in the evening.

In optional act 125 of the method, the user can create a stack of content: e.g., long form, short form, long form, etc. In addition, the user can assign time periods or limits on either form of content: e.g., 5 minutes of weather; 3 minutes of sports; 10 minutes of NPR, etc.

Once the user has programmed a preset of the streaming music player, the user may decide whether to program further presets (act 130). If the user wants to program further presets the method returns to act 105 and the user programs another preset of the streaming music player. If the user has programmed all of the presets desired, the method ends at act 135 and the user may begin to use the programmed presets to listen to the programmed long form and short form content.

In some implementations, information regarding how the user programmed each preset of a streaming music player may be stored in an online or cloud-based user account associated with the user or the user's streaming music player. The user may access the information regarding the programming of the different presets stored in the user's accounts using different streaming music players to assign different or at least one common preset to the different streaming music players.

In some implementations, the user may program or schedule long form and short form content for more presets than are physically present on the user's streaming music player. Information regarding the programming of unused long form content and short form content combinations may be stored in the streaming music player, the controller for the streaming music player, or in an online user account associated with the user or the user's streaming music player. The user may reassign combined long form/short form preset combinations to the user's streaming music player(s) without having to reprogram the combined long form/short form preset combinations each time, for example, by downloading one or more indications of combinations of long form and short form content from the user's on-line account to a streaming music player and assigning the one or more combination of long form and short form content to one or more presets of the streaming music player.

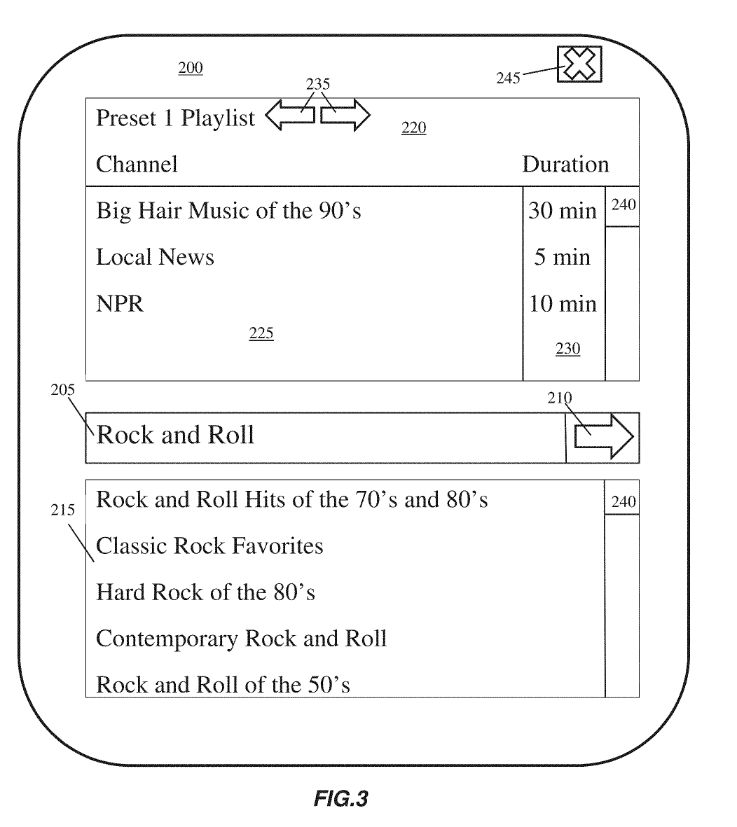

An implementation of a user interface 200 that a user may access on a display of a streaming music player or streaming music player controller for assigning long form/short form preset combinations to presets of a streaming music player is illustrated in FIG. 3. The user interface 200 may be invoked by selecting an associated icon on the display of the streaming music player or streaming music player controller. The user interface 200 includes a search bar into which a user may enter a search term for a streaming audio channel, for example, “Rock and Roll” as indicated in FIG. 3. After entering a search term, the user may search for relevant streaming audio channels by selecting a “perform search” icon 210. Available streaming audio channels that the streaming music player or associated computer system considers to be relevant to the search term are presented in results window 215.

Content currently assigned to a preset is illustrated in a preset content window 220. The preset content window 220 includes a channel window 225 illustrating channels currently assigned to a preset. A duration column 230 illustrates durations that the user has assigned to each of the channels to play for when the preset is selected. In some implementations, the channels assigned to the preset repeat in a loop where each channel is played for the assigned time in each loop. In other implementations a user may enter a value such as “balance” or “n/a” in the duration column 230 for a particular channel and the streaming music player will continue to play the particular channel until turned off or a until another preset is selected.

A user may add a channel from the results window 215 into the channel window 225 by, for example, dragging and dropping the channel from the results window 215 into the channel window 225 with a mouse or other pointer device or by dragging and dropping by touch if the user interface 200 is presented in a touch screen display. The user may drop a new channel into the channel window 225 before, after, or between existing assigned channels. The user may remove assigned channels from the channel window 225 by dragging one of the assigned channels out of the channel window 225 onto any other portion of the user interface 200. Once a channel is present in the channel window 225 the user may assign a duration of play to the channel by entering a duration value in the duration column 230 for that channel.

The user interface further includes selection arrows 235 that may be selected to change the preset to view or modify the playlist of a different preset. Scroll indicators 240 may be manipulated to scroll up and down through the list of channels in the results window 215 or channel window 225 if the list of channels in these windows exceed the size of the windows.

A user may select a “close” icon 245 to close the user interface 200 when finished viewing or modifying preset playlists.

### Dynamic Presets

In some implementations presets of a streaming music player may be dynamically adjustable and may automatically change the amount or type of long form and/or short form content played over time. As discussed above, some forms of dynamic adjustment include automatically changing the type and/or amount of long form and/or short form content played by a given preset based on time of day, day of the week, time of year, and/or location of user.

In some implementations, a preset of a streaming music player may dynamically adjust the type and/or amount of long form and/or short form content played based on one or more parameters (e.g., time of day, day of the week, time of year, location of user and/or prior usage) over time without having been programmed by a user to perform the specific form of dynamic adjustment. Rather, the streaming music player may keep a record of what the user listens to and when, deduce the user's preferences or tastes from the record, and adjust the content played when one or more of the preset indicators are selected based on the deduced user preferences or tastes.

In some implementations, a user could instruct the streaming music player to make one of its preset indicators a dynamically adjusted preset. The streaming music player may save a record of the times a user listens to short form content and long term content, the types of short term and long term content, and the relative amount of time the user listens to the different types of short form and long form content and may dynamically adjust the content played when the dynamically adjusted preset is selected based on the record. For example, if the user typically listens to news for about 15 minutes around breakfast time on weekdays and music while commuting to work and listens to music and streaming sports radio during the evening commute, the streaming music player, or a computer separate from but in communication with the streaming music player, may program the dynamically adjusted preset to play streaming news during the weekend mornings, music similar to that the user previously listened in the user's commute to work during the time of the user's morning commute, and music similar to that the user previously listened to in the user's evening commute during the time of the user's evening commute, periodically interrupted by short form streaming sports news reporting news similar to that the user previously tended to favor.

In another form of dynamic adjustment, the streaming music player, or associated computer, may monitor how the user programmed other presets of the streaming music player and which presets the user listened to most, and may adjust a designated dynamically adjustable preset based on the mix of short form and long form content the user listened to on the other presets to provide the user with a similar experience with the dynamically adjustable preset that they enjoyed using the other presets of the streaming music player.

In a further method of automatic adjustment, a streaming music player or associated computer system may gather information about a user and program a designated dynamically adjustable preset to include a mix of long form and short form content that the streaming music player or associated computer system predicts the user would enjoy based upon the gathered information. The streaming music player or associated computer system may program the dynamically adjustable preset to play the long form and short form content at a schedule the streaming music player or associated computer system predicts the user would enjoy based upon the gathered information. In some implementations, the streaming music player or associated computer system may gather information about a user by presenting a user with a survey regarding, for example, age, gender, location, etc. In other implementations, a user may grant the streaming music player or associated computer system access to the user's computer or telephone to see what types of music the user has stored or has purchased. The user may additionally or alternatively grant the streaming music player or associated computer system access to the user's schedule so the streaming music player or associated computer system may deduce when the user is at home, at work, or commuting. The streaming music player or associated computer system may compare the information gathered about the user to identify similar users and program the designated dynamically adjustable preset to include a mix of long form and short form content that the streaming music player or associated computer system determined that other users similar to the user tended to listen to and at a schedule (e.g., when and how much short form vs. long form audio is played) similar to a schedule that the similar users tended to use.

In some implementations the streaming music player or associated computer system may provide the user with information regarding changes made to the dynamically adjustable preset, and optionally, why the changes were made.

The various computer systems disclosed herein, for example, a computer system hosting the online streaming music account of a user, the streaming music controller 50, or a computer system that is used to make predictions of what type of audio content and scheduling for same the user might enjoy and to program a dynamically adjustable preset for the user, may include specialized software executing in a general-purpose computer system 300 such as that shown in FIG. 3. The computer system 300 may include a processor 302 connected to one or more memory devices 304, such as a disk drive, solid state memory, or other non-transitory recording medium for storing data. Memory 304 is typically used for storing programs and data during operation of the computer system 300. Components of computer system 300 may be coupled by an interconnection mechanism 306, which may include one or more busses (e.g., between components that are integrated within a same machine) and/or a network (e.g., between components that reside on separate discrete machines). The interconnection mechanism 306 enables communications (e.g., data, instructions) to be exchanged between system components of system 300. Computer system 300 also includes one or more input devices 308, for example, a keyboard, mouse, trackball, microphone, touch screen, and one or more output devices 310, for example, a printing device, display screen, and/or speaker.

The computer system may include specially-programmed, special-purpose hardware, for example, an application-specific integrated circuit (ASIC). Aspects and embodiments disclosed herein may be implemented in software, hardware or firmware, or any combination thereof. Further, such methods, acts, systems, system elements and components thereof may be implemented as part of the computer system described above or as an independent component.

Although computer system 300 is shown by way of example as one type of computer system upon which various aspects and embodiments disclosed herein may be practiced, it should be appreciated that aspects and implementations disclosed herein are not limited to being implemented on the computer system as shown in FIG. 3. Various aspects and implementations disclosed herein may be practiced on one or more computers having a different architecture or components than shown in FIG. 3.

Computer system 300 may be a general-purpose computer system that is programmable using a high-level computer programming language. Computer system 300 may be also implemented using specially programmed, special purpose hardware. In computer system 300, processor 302 is typically a commercially available processor such as the well-known Pentium™ or Core™ class processors available from the Intel Corporation. Many other processors are available, including programmable logic controllers. Such a processor usually executes an operating system which may be, for example, the Windows 7, Windows 8, or Windows 10 operating system available from the Microsoft Corporation, the MAC OS System X available from Apple Computer, the Solaris Operating System available from Sun Microsystems, or UNIX available from various sources. Many other operating systems may be used.

One or more portions of the computer system may be distributed across one or more computer systems (not shown) coupled to a communications network. These computer systems also may be general-purpose computer systems. For example, various aspects of the invention may be distributed among one or more computer systems configured to provide a service (e.g., servers) to one or more client computers, or to perform an overall task as part of a distributed system. For example, various aspects and embodiments disclosed herein may be performed on a client-server system that includes components distributed among one or more server systems that perform various functions according to various aspects and embodiments disclosed herein. These components may be executable, intermediate (e.g., IL) or interpreted (e.g., Java) code which communicate over a communication network (e.g., the Internet) using a communication protocol (e.g., TCP/IP). In some embodiments one or more components of the computer system 300 may communicate with one or more other components over a wireless network, including, for example, a cellular telephone network.

It should be appreciated that the aspects and implementations disclosed herein are not limited to executing on any particular system or group of systems. Also, it should be appreciated that the aspects and implementations disclosed herein are not limited to any particular distributed architecture, network, or communication protocol. Various aspects and implementations disclosed herein are may be programmed using an object-oriented programming language, such as SmallTalk, Java, C++, Ada, or C# (C-Sharp). Other object-oriented programming languages may also be used. Alternatively, functional, scripting, and/or logical programming languages may be used, for example, ladder logic. Various aspects and implementations disclosed herein may be implemented in a non-programmed environment (e.g., documents created in HTML, XML or other format that, when viewed in a window of a browser program, render aspects of a graphical-user interface (GUI) or perform other functions). Various aspects and implementations s disclosed herein may be implemented as programmed or non-programmed elements, or any combination thereof.

Having thus described several aspects of at least one implementation, it is to be appreciated various alterations, modifications, and improvements will readily occur to those skilled in the art. Such alterations, modifications, and improvements are intended to be part of this disclosure, and are intended to be within the spirit and scope of the disclosure. The acts of methods disclosed herein may be performed in alternate orders than illustrated, and one or more acts may be omitted, substituted, or added. One or more features of any one example disclosed herein may be combined with or substituted for one or more features of any other example disclosed. Accordingly, the foregoing description and drawings are by way of example only.

The phraseology and terminology used herein is for the purpose of description and should not be regarded as limiting. As used herein, the term “plurality” refers to two or more items or components. As used herein, dimensions which are described as being “substantially similar” should be considered to be within about 25% of one another. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

What is claimed is:

1. A method of assigning streaming audio content to a preset of a streaming music player of a user, the method comprising:
receiving an indication of long form streaming audio content for a user;
receiving an indication of short form streaming audio content for the user, the long form streaming audio content and the short form streaming audio content being supplied from different sources; and
configuring a preset of the streaming music player of the user to play the long form streaming audio content and the short form streaming audio content responsive to the preset being selected.

2. The method of claim 1, wherein receiving the indication of the long form streaming audio content and the indication of the short form streaming audio content comprises receiving the indication of the long form streaming audio content and the indication of the short form streaming audio content from the user.

3. The method of claim 2, further comprising receiving a schedule for playing the long form streaming audio content and the short form streaming audio content and playing the long form streaming audio content and the short form streaming audio content in accordance with the schedule responsive to the preset being selected.

4. The method of claim 3, wherein receiving the schedule includes receiving an indication of timing of when to interrupt playing of the long form streaming audio content with the short form audio content.

5. The method of claim 3, wherein receiving the schedule includes receiving an indication of a type of short form audio content to play based on criteria including one or more of duration, time of day, day of week, season, or location of user.

6. The method of claim 3, wherein receiving the schedule includes receiving an indication of a type of long form audio content to play based on criteria including one or more of duration, time of day, day of week, season, or location of user.

7. The method of claim 3, wherein receiving the schedule includes receiving an indication of a first type of short form audio content to interrupt playing of the long form audio content at a first periodic basis and an indication of a second type of short form audio content to interrupt playing of the long form audio content at a second periodic basis.

8. The method of claim 1, wherein receiving the indication of the long form streaming audio content and the indication of the short form streaming audio content comprises receiving the indication of the long form streaming audio content and the indication of the short form streaming audio content from a computer system that predicted a type of long form streaming audio content and a type of short form streaming audio content that the user would likely enjoy based on one or more characteristics of the user.

9. The method of claim 8, further comprising:
creating, by the computer system, a schedule for playing the long form streaming audio content and the short form streaming audio content that the user would likely enjoy based on one or more characteristics of the user; and
playing the long form streaming audio content and the short form streaming audio content in accordance with the schedule responsive to the preset being selected.

10. The method of claim 1, wherein receiving the indication of short form streaming audio content comprises receiving an indication of short form streaming audio content from a plurality of sources.

11. The method of claim 1, further comprising interrupting playing of the long form audio content with the short form audio content responsive to an occurrence of an event.

12. The method of claim 11, further comprising monitoring, by the steaming music player, external sources of information for an indication of the occurrence of the event.

13. The method of claim 11, further comprising programming the streaming music player to perform a specific action responsive to receipt of an indication of the occurrence of the event.

14. The method of claim 1, further comprising interrupting playing of the short form audio content responsive to receiving an indication of an occurrence of an event from an external source of information monitored by the streaming music player.

15. The method of claim 1, further comprising:
receiving indications of long form streaming audio content and short form audio content for more presets than are physically present on the streaming music player;
storing the indications of long form streaming audio content and short form audio content in an online account of the user;
downloading one or more of the indications of long form streaming audio content and short form audio content to the streaming music player; and
assigning the one or more of the indications of long form streaming audio content and short form audio content to one or more respective presets of the streaming music player.

16. The method of claim 1, wherein configuring the preset of the streaming music player comprises configuring a virtual preset accessible and selectable through a controller of the streaming music player.

17. A computer system comprising a processor and a non-transitory computer readable memory including instructions that when executed by the processor cause the computer system to:
receive an indication of long form streaming audio content and short form streaming audio content for a user, the long form streaming audio content and the short form streaming audio content being supplied from different sources; and
configure a preset of a streaming music player of the user to play the long form streaming audio content and short form streaming audio content responsive to the preset being selected.

18. The system of claim 17, wherein the instructions, when executed by the processor, further cause the computer system to:
receive a schedule for playing the long form streaming audio content and the short form streaming audio content, the schedule including an indication of timing of when to interrupt playing of the long form streaming audio content with the short form audio content and an indication of a type of short form audio content to play based on criteria including one or more of time of day, day of week, season, and location of user; and
configure the preset of the streaming music player of the user to play the long form streaming audio content and short form streaming audio content in accordance with the schedule.

19. The system of claim 18, wherein the instructions, when executed by the processor, further cause the computer system to dynamically adjust one or more of a type of the long form streaming audio content, a type of the short form streaming audio content, or the schedule based on one or more characteristics or actions of the user.

20. A streaming music player comprising:
a processor;
a network interface operatively coupled to the processor and configured to access streaming audio content from one or more streaming audio content sources;
an electro-acoustic transducer operatively coupled to the processor;
a plurality of preset indicators operatively coupled to the processor, each of the plurality of preset indicators configured to initiate streaming and rendering of a combination of long form audio content and short form audio content from different streaming audio content sources through the electro-acoustic transducer.

21. The streaming music player of claim 20, further comprising a memory operatively coupled to the processor, the memory including programming which when executed by the processor causes the processor to access a cloud-based database including account information associated with the streaming music player including a set of combinations of indications of long form streaming audio content and short form audio content from different streaming audio content sources and to assign one of the combinations to one of the plurality of preset indicators.
